(19) United States
(12) Patent Application Publication
(10) Pub. No.: US 2019/0306601 A1
(43) Pub. Date: Oct. 3, 2019

(54) iPendant Speakerchain

(71) Applicant: Marcus Elorme, Margate, FL (US)

(72) Inventor: Marcus Elorme, Margate, FL (US)

(21) Appl. No.: 15/942,771

(22) Filed: Apr. 2, 2018

(51) Int. Cl. H04R 1/02

(52) U.S. Cl. CPC H04R 1/028; H04R 2420/07

(57) ABSTRACT

The present invention relates generally to an apparatus for a pendant. More specifically, the present invention is an apparatus for a pendant that houses multimedia devices, giving them a boost in volume without having to hold the device in the hands. The device is worn around the neck hence, the correlation to a pendant.

### BACKGROUND OF THE INVENTION

Many smartpbone users love to listen to their music through their speakers and it is very convenient in the company of friends. A common problem is the sound quality and volume coming from the phone's or any multimedia device's speaker. Frequently, users want better sound quality and louder volume depending on the occasion and situation. The present invention looks to introduce an apparatus for a pendant that houses multimedia devices, giving them a boost in volume. For example the user would connect their cellphone to the multimedia device that is placed in the apparatus for a pendant. This gives the user a hands free experience of volume being worn around their neck. Usually you would have to move the cellphone up and down so everyone intended to listen can hear what is being played through the cellphones speaker. By wearing the speaker around the neck in a pendant, a lot more people can hear the song or whatever form of media is being played from the multimedia device. This will give you a more convenient way to listen to different forms of media.

### BRIEF DESCRIPTION OF THE DRAWINGS

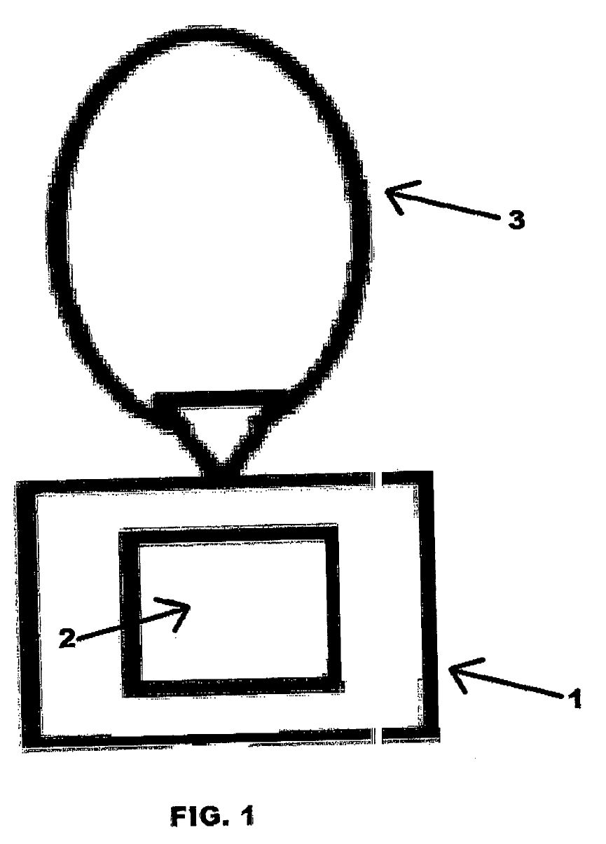

FIGURE 1
1. Drawing of the apparatus for a pendant used to carry any multimedia device.
2. This is the area in the apparatus used to carry a Bluetooth speaker or any multimedia device.
3. This is the necklace used to wear the apparatus.

### DETAILED DESCRIPTION

All illustrations of the drawings are for the purpose of describing selected versions of the present invention and are not intended to limit the scope of the present invention. The preferred embodiment of the present invention may be referred to hereinafter as “Speakerchain”. The present invention is a pendant that houses a multimedia device, for example, my first product, “DaGerm Speakerchain”, which houses or encloses a Bluetooth Speaker. The pendant can be any shape or object created or yet to be created. “DaGerm Speakerchain” is a graphic which l have copy written and designed as a pendant that houses a Bluetooth speaker. That speaker connects to any multimedia device, for example, the user's cellphone or tablet.

A known problem when using cell phones, tablets, or any multimedia device is that the volume tends to be very low or basic. The “Speakerchain” will change that, by giving the user an instant volume and bass boost by connecting to their multimedia devices. All while giving the user a highly fashionable chain to wear at the same time. Great for the beach, those who walk, or ride the bus by instantly giving the user access to their phones playlist or whichever multimedia device their using. The “Speakerchain” can also be used for advertising. For example, a hot dog vendor can record a message on their cellphone such as “hot, hot, bot, dogs, 0.99 cents or 2 for $1.50!!!” and have it playing on repeat through their cell phone. The cellphone would then connect to the “Speakerchain” giving the cellphone an instant boost in volume for those walking in the vicinity would know exactly what is for sale.

Although the invention has been explained in relation to its preferred embodiment, it is to be understood that many other possible modifications and variations can be made without departing from the spirit and scope of the invention. For example, the Bluetooth speaker could become a touch screen, cell phone, tablet, or any other multimedia device. This would combine the speaker and multimedia device into one apparatus for a pendant.

1. This apparatus for a pendant has an area where a multimedia device can be placed or held.

2. This apparatus is worn around the neck.
